(19) United States
(12) Patent Application Publication
(10) Pub. No.: US 2014/0038628 A1
(43) Pub. Date: Feb. 6, 2014

(54) Apparatus and Method for Communication

(71) Applicants: Jian Feng Qiang, Beijing (CN); Seppo Ilmari Vesterinen, Oulunsalo (FI); Jari Yrjana Hulkkonen, Oulu (FI)

(72) Inventors: Jian Feng Qiang, Beijing (CN); Seppo Ilmari Vesterinen, Oulunsalo (FI); Jari Yrjana Hulkkonen, Oulu (FI)

(73) Assignee: NOKIA SIMENS NETWORKS OY, ESPOO (FI)

(21) Appl. No.: 14/111,641

(22) PCT Filed: Apr. 15, 2011
(86) PCT No.: PCT/EP11/56030

§ 371 Date: Oct. 14, 2013

(51) Int. Cl. H04W 72/04

(52) U.S. Cl. CPC H04W 72/0453
USPC 455/452.1

(57) ABSTRACT

Apparatus and method for communication are provided. The solution includes a first server of an operator specific communication system configured to perform the administration and management tasks of the operator specific communication system including one or more radio access technologies, communicate with the respective server of one or more communication systems of another operators, and a second server configured to manage mobility policy of the operator specific communication sys-tem, communicate with the user terminals of the system by transmitting information on inter-system radio access network selection and access, wherein the first and second server are configured each to maintain an interworking data model including information on operator specific cognitive radio parameters and access policies related to networks of one or more operators.

### FIELD

The exemplary and non-limiting embodiments of the invention relate generally to wireless communication networks. Embodiments of the invention relate especially to an apparatus and a method in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

With the ever increasing demand for increasing data rates and higher quality services in the world of mobile communications comes ever increasing demand for better performance of cellular network infrastructures. The available frequency resources are limited and need for efficient use of the resources is essential. The need for more efficient usage of radio resources has brought out an idea of co-existence or sharing of systems meaning that systems share operational resources, for example spectrum in a given region at a time. The fair sharing of limited radio resources is a difficult task. Especially sharing the resources between different operators requires an infrastructure capable of reliable sharing.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus, comprising: at least one processor; and at least one memory including computer program code, the at least one memory and the computer program code configured to, with the at least one processor, cause the apparatus at least to perform: perform the administration and management tasks of the operator specific communication system comprising one or more radio access technologies, maintain an interworking data model comprising information on operator specific cognitive radio parameters and access policies related to networks of one or more operators and communicate with a network element of the operator specific communication system configured to provide network discovery and selection with information elements comprising at least one element indicating networks of one operator or different operators supporting cognitive radio; at least one element indicating the radio frequency bands available for cognitive radio and parameters related to the frequency bands.

According to another aspect of the present invention, there is provided an apparatus, comprising: at least one processor; and at least one memory including computer program code, the at least one memory and the computer program code configured to, with the at least one processor, cause the apparatus at least to perform: provide an operator specific communication system comprising one or more radio access technologies network discovery and selection, receive and store from a network element configured to perform the administration and management tasks of the operator specific communication system information elements comprising at least one element indicating networks of one operator or different operators supporting cognitive radio; at least one element indicating the radio frequency bands available for cognitive radio and parameters related to the frequency bands.

According to another aspect of the present invention, there is provided an arrangement, comprising: a first server of an operator specific communication system configured to perform the administration and management tasks of the operator specific communication system comprising one or more radio access technologies, communicate with the respective server of one or more communication systems of another operators, and a second server configured to manage mobility policy of the operator specific communication system, communicate with the user terminals of the system by transmitting information on inter-system radio access network selection and access, wherein the first and second server are configured each to maintain an interworking data model comprising information on operator specific cognitive radio parameters and access policies related to networks of one or more operators.

According to another aspect of the present invention, there is provided a method comprising: performing the administration and management tasks of the operator specific communication system comprising one or more radio access technologies, maintaining an interworking data model comprising information on operator specific cognitive radio parameters and access policies related to networks of one or more operators and communicating with a network element of the operator specific communication system configured to provide network discovery and selection with information elements comprising at least one element indicating networks of one operator or different operators supporting cognitive radio; at least one element indicating the radio frequency bands available for cognitive radio and parameters related to the frequency bands.

According to another aspect of the present invention, there is provided a method comprising: providing an operator specific communication system comprising one or more radio access technologies network discovery and selection, receiving and storing from a network element configured to perform the administration and management tasks of the operator specific communication system information elements comprising at least one element indicating networks of one operator or different operators supporting cognitive radio; at least one element indicating the radio frequency bands available for cognitive radio and parameters related to the frequency bands.

### LIST OF DRAWINGS

Embodiments of the present invention are described below, by way of example only, with reference to the accompanying drawings, in which

FIG. 1 shows a simplified block diagram illustrating an example of system architecture;

FIGS. 2A, 2B and 2C illustrate examples of apparatuses according to embodiments of the invention; and

FIGS. 3A and 3B are flowcharts illustrating examples of embodiments of the invention.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any base station, user equipment, server, network element, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

In the following, different embodiments will be described using, as an example of a system architecture whereto the embodiments may be applied, an architecture derived from Evolved UMTS terrestrial radio access (E-UTRA, UMTS=Universal Mobile Telecommunications System) without restricting the embodiment to such an architecture, however.

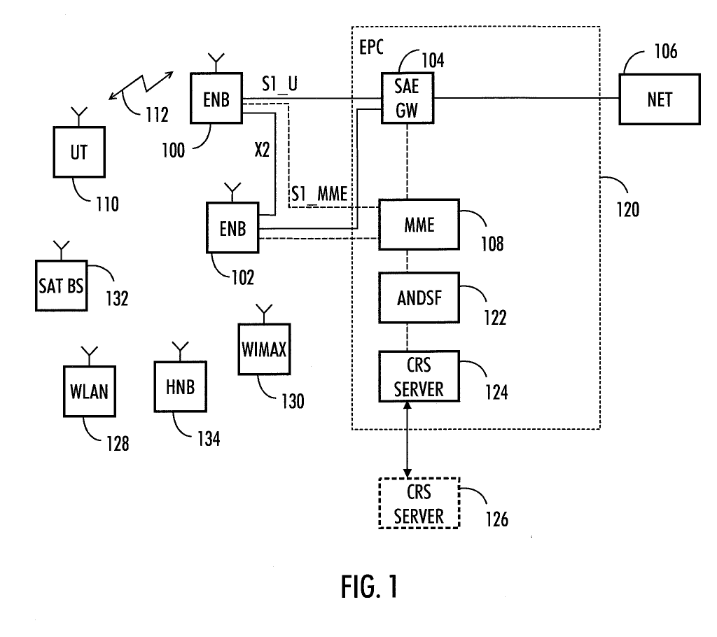

With reference to FIG. 1, let us examine an example of a radio system to which embodiments of the invention can be applied. In this example, the radio system is derived from LTE network elements. However, the invention described in these examples is not limited to a system based on LTE radio systems but can also be implemented in systems based on other radio systems.

A general architecture of a communication system is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements, and protocols used in or for group communication are irrelevant to the actual invention. Therefore, they need not be discussed in more detail here. The exemplary radio system of FIG. 1 comprises the evolved packet core EPC or the service core 120 of an operator including the following elements: an MME (Mobility Management Entity) 108, an SAE GW (SAE Gateway) 104, a Cognitive Radio System server CRS 124 and an Access Network Discovery and Selection Function ANDSF 122. It should be appreciated that the communication system may also comprise other core network elements besides mentioned.

Base stations that may also be called eNodeBs (Enhanced node Bs) 100, 102 of the radio system may host the functions for Radio Resource Management: Radio Bearer Control, Radio Admission Control, Connection Mobility Control, Dynamic Resource Allocation (scheduling). The MME 108 is responsible for the overall user terminal control in mobility, session/call and state management with assistance of the eNodeBs through which the user terminals connect to the network. The eNodeBs are connected to the SAE GW with an S1_U interface and to MME with an S1_MME interface. The eNodeBs may communicate with each other using an X2 interface. The SAE GW 104 is an entity configured to act as a gateway between the network and other parts of communication network such as the Internet 106, for example. The SAE GW may be a combination of two gateways, a serving gateway (S-GW) and a packet data network gateway (P-GW).

FIG. 1 illustrates user equipment UE 110 located in the service area of the eNodeB 100. User equipment refers to a portable computing device. Such computing devices include wireless mobile communication devices, including, but not limited to, the following types of devices: mobile phone, smartphone, personal digital assistant (PDA), handset, laptop computer. The apparatus may be battery powered. In the example situation of FIG. 1, the user equipment 110 has a connection 112 with the eNodeB 100. The connection 112 may be a bidirectional connection related to a speech call or a data service such as browsing the Internet 110.

FIG. 1 only illustrates a simplified example. In practice, the network may include more base stations and more cells may be formed by the base stations. The networks of different operators may overlap; the sizes and form of the cells may vary. In addition, there may be overlapping networks based on different access technologies. For example, in some hot spot areas there may be Wireless Local Area Networks (WLAN) 128 or worldwide interoperability for microwave access (WiMAX) networks 130. In addition, some geographical area may be served by a satellite base station 132.

Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells.

For example, the eNodeB 100 of FIG. 1 may provide any kind of these cells. A cellular radio system may be implemented as a multilayer network including several kinds of cells. Typically, in multilayer networks, one eNodeB provides one kind of a cell or cells, and thus a plurality of eNodeBs are required to provide such a network structure.

Recently for fulfilling the need for improving the deployment and performance of communication systems, concept of “plug-and-play” eNodeBs has been introduced. These nodes may be denoted as Home NodeBs (HNB) 134. Typically, in the LTE (advanced), a network which is able to use “plug-and-play” HNBs, includes, in addition to HNBS, a home node B gateway, or HNB-GW (not shown in FIG. 1). A HNB Gateway (HNB-GW), which is typically installed within an operator's network aggregates traffic from a large number of HNBs back to a core network through Iu-cs and Iu-ps interfaces.

With increasing number of personal, local and wireless communication systems operating in a same geographical area, the questions of co-existence and inter-networking are raised. Cognitive and re-configurable radios may be a key for obtaining a heterogeneous communication environment where mitigation techniques and cognitive signalling are used for sharing the spectrum and routing information.

Cognitive radios are designed to efficient spectrum use deploying so-called smart wireless devices being capable to sense and detect the environment and adapt to it thus being suitable for opportunistic spectrum usage, in which also the frequency bands not being used by their primary (usually licensed) users may be utilized by secondary users. For this purpose cognitive radios are designed to detect unused spectrum, such as spectrum holes. In addition, operators may agree on some shared frequencies which may be used in collaboration. This is denoted as spectrum trade concept.

To be able to communicate efficiently cognitive user terminals need to obtain knowledge of its radio environment. One possibility is that a cognitive user terminal measures or senses parts of the spectrum. However, this is a very time and power consuming operation if the parts of the spectrum to be sensed are large. In an embodiment, a Cognitive Pilot Channel CPC may be utilised. The CPC is a channel which is used by the communication system to transmit information regarding cognitive radio parameters to user terminals. The CPC may be transmitted in the communication system using a dedicated radio connection. This is called an out-band CPC. In an in-band CPC solution, the CPC is transmitted as a logical channel within one or more available radio access technologies.

In an embodiment, the communication system comprises a Cognitive Radio System server CRS 124. The server 124 is configured to perform the administration and management tasks of the operator specific communication system comprising one or more radio access technologies. The server is configured to manage and supervise the network elements in the communication system. The server may perform Configuration Management (CM) such as controlling static Radio and Transport Network configuration parameters in base stations of the system, Fault Management (FM) such as alarm reporting and recovery in failure cases, Performance Management (PM) such as collecting dynamic information from the network elements e.g. for statistics, or fine tuning radio network parameters and Software Management (SWM) of the network elements.

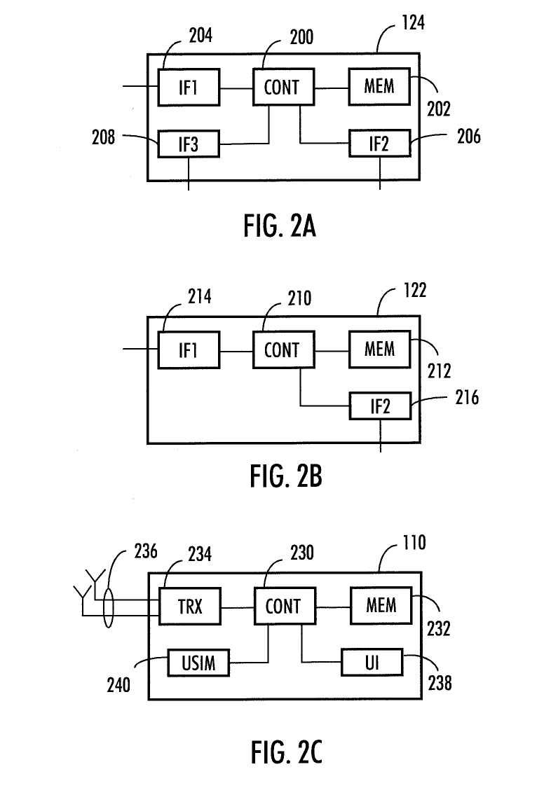

FIG. 2A illustrates a simplified example of an apparatus of an embodiment. The apparatus may be a Cognitive Radio System server CRS 124. In some embodiments, the apparatus may be realized as a single entity or a server. The apparatus may also be realized with more than one entity or server.

The apparatus of the example includes a communication control circuitry 200 configured to control at least part of the operation of the server.

The apparatus may comprise a memory 202 for storing data. Furthermore the memory may store software executable by the control circuitry 200. The memory may be integrated in the control circuitry. The software may comprise a computer program comprising program code means adapted to perform any of steps described above and below in relation to the Cognitive Radio System server CRS 124. The apparatus may be configured to maintain in the memory 202 an interworking data model comprising information on operator specific cognitive radio parameters and access policies related to networks of more than one operator. The apparatus may further comprise interface circuitry 204 configured to connect and communicate with the respective apparatuses 126 of one or more communication systems of another operators in order to facilitate inter-operator multi-RAT cognitive radio environment.

In an embodiment, the communication system comprises an Access Network Discovery and Selection Function server ANDSF 122. The ANDSF server may be configured to manage the mobility policy of the operator specific communication system and communicate with the user terminals of the system by transmitting information on inter-system radio access network selection and access. The ANDSF 122 provides the user terminals information on the networks of the communication system, the networks being realized with different access technologies. In addition, the ANDSF may maintain a data model similar to the one kept by the CRS server 124 comprising cognitive radio parameters. In an embodiment, the CRS 124 is configured to send cognitive radio related information to the ANDSF 122. The ANDSF is configured to distribute the information to the user terminals. The ANDSF may transmit an in-band Cognitive Pilot Channel CPC using an Internet Protocol connection, for example.

In an embodiment, the CRS 124 may comprise a circuitry 206 for realizing an interface between the CRS 124 and the ANDSF 122. The interface is used to transmit signaling messages comprising at least one element indicating networks of different operators supporting cognitive radio and at least one element indicating the radio frequency bands available for cognitive radio and parameters related to the frequency bands. The circuitry 206 may realize the interface with a wired or wireless connection.

The information in the data model and communicate over the interface between the CRS and the ANDSF may comprise cognitive radio specific inter-network Information. The inter-network could be inter-operator or intra-operator. Different network is could be indexed by Public Land Mobile Network identification PLMN ID. The information may comprise inter-network policies, such as spectrum access priorities and parameters, for example. In addition, dynamic frequency assignment with RAT info may be included.

In an embodiment, the radio frequency bands available for cognitive radio may be indicated with a flag bit of a cognitive radio band. The flag bit indicates whether a certain radio band is supporting cognitive radio or not. The flag bit may indicate whether the cognitive radio band is for spectrum trade or opportunity-driven secondary access.

The measurement behaviours on different frequency bands and different RATs are typically different. If a frequency band is supporting cognitive radio, the information related to measurements on the band may be indicated. The information may comprise radio measurement objects and measurement cycles, for example.

In addition, geographic information related to the frequency bands may be included in the data model and transmitted information. For example, for each frequency band supporting cognitive radio, information related to the coverage area of the band may be indexed by PLMN ID, tracking area, routing area, cell ID, or some geo-location information such as base station location, cell radius and sector information, for example.

Information on possible limitations in the use of the frequency band may be included in the data model and transmitted information. For example, due to interference from adjacent carrier where different RAT may be in use, there may be some guard area between different correspondence of carrier frequency and RAT configuration. To ease the use of different radio access technologies, the data model and information transmitted from CRS server to the ANDSF may comprise timing information of different RATs. For example, different access technologies may have different frame structures. In 3GPP access technologies, a 10 ms radio frame is used. 3GPP2 and WLAN based systems have different frames lengths. Switching from one access technology to another should take a timing gap into account. In addition, in the spectrum trade case validity period, sleep cycle, measurement gap per band should be noted, for example. In the opportunity-driven secondary access case, burst cycle and measurement gap are examples of important parameters. In general, information related to timings and measurements may be included.

Reliable detecting of different RAT signals in a short time window is a challenging task. Therefore RAT signal sensing and RAT access aided info may be included. Network service capability information indicates the user terminal the specific services supported by only certain radio network or frequency. Examples of such services may be Multimedia Broadcast and Multicast Services (MBMS) service and real-time video service. Information to speed up cell search and RAT signal sensing procedure may relate to root sequence info of cell ID, for example. RAT or band load balance info may comprise load status of a cell. This may be helpful while certain RAT cell is overloaded, so a cognitive radio terminal may access other RAT or band according to the load info.

In an embodiment, the CRS server 124 is configured to send cognitive radio related information to the eNodeBs. An interface between CRS server and eNodeB may be defined, over which interface cognitive radio control information is distributed from the CRS server to eNodeBs. The cognitive radio control information of an eNodeB or base station is similar with that of high-layer CPC information to user terminal since both the base station and User terminal are transceivers in a same frequency. The base station or eNodeB may flexibly switch the RAT & frequency correspondence according to the control information.

In an embodiment, the apparatus of FIG. 2A may further comprise an interface circuitry 208 configured to connect the apparatus to eNodeBs or base stations for sending cognitive radio related information. The cognitive radio control information of an eNodeB or base station is similar with that of high-layer CPC information to user terminal since both the base station and user terminal are transceivers in a same frequency. The base station or eNodeB may flexibly switch the radio access technology and frequency correspondence according to the control information.

FIG. 2B illustrates a simplified example of an apparatus of an embodiment. The apparatus may be the Access Network Discovery and Selection Function server ANDSF 122. In some embodiments, the apparatus may be realized as a single entity or a server. The apparatus may also be realized with more than one entity or server.

The apparatus of the example includes a communication control circuitry 210 configured to control at least part of the operation of the server.

The apparatus may comprise a memory 212 for storing data. Furthermore the memory may store software executable by the control circuitry 210. The memory may be integrated in the control circuitry. The software may comprise a computer program comprising program code means adapted to perform any of steps described above and below in relation to the Access Network Discovery and Selection Function server ANDSF 122.

The apparatus may further comprise interface circuitry 214 configured to connect and communicate with the Cognitive Radio System server CRS 124 using the interface described above. The apparatus may be configured to receive system information elements comprising at least one element indicating networks of different operators supporting cognitive radio; at least one element indicating the radio frequency bands available for cognitive radio and parameters related to the frequency bands.

The apparatus may be configured to maintain in the memory 212 an interworking data model comprising information on operator specific cognitive radio parameters and access policies related to networks of more than one operator, the information having been received from the CRS 124. The apparatus of FIG. 2B is configured to distribute the information to the user terminals. The apparatus may comprise interface circuitry 216 configured to connect and communicate with user terminals one or more user terminal of the system information regarding cognitive radio parameters related to networks of more than one operator. The apparatus may transmit an in-band Cognitive Pilot Channel CPC using an Internet Protocol connection, for example.

In LTE based systems, the Access Network Discovery and Selection Function server ANDSF 122 is used to aid the user terminals in the selection of a suitable access type and network in cases when the operator's system supports multiple networks and access technologies. The ANDSF is configured to provide to the user terminals data and policies about available accesses to allow the terminals to scan for accesses and select an access. This enables the operator to influence the access that each user terminal shall handover to (when in active mode) or re-select (when in idle mode).

In an embodiment, the ANDSF is further configured to receive and store from the CRS server information elements comprising cognitive radio information such as at least one element indicating networks of different operators supporting cognitive radio; at least one element indicating the radio frequency bands available for cognitive radio and parameters related to the frequency bands.

The ANDSF may provide the selection and access information to the user terminals in management objects (ANDSF MO). In an embodiment, the management object comprises information of the types of base stations supporting cognitive radio operation. The base stations may be of different access types and under systems of different operators.

The ANDSF MO may comprise information on user terminals and the cognitive radio properties of the terminals. For example, the cognitive radio capability information may limit the data provided by the ANDSF to the terminals. For example, the cognitive radio capability information may indicate the cognitive radio types supported by the terminal. The information may comprise a flag bit to show whether the terminal is cognitive radio enabled or not, the supported cognitive radio type (spectrum trade or secondary white-space access, for example), the supported RAT mode or band number of the terminal, etc.

In an embodiment, the ANDSF is configured to send cognitive radio information to a user terminal when requested by the user terminal. In an embodiment, the ANDSF is configured to send the parameters automatically whenever the parameters have changed. For example, the ANDSF may receive from the CRS server information where a network or band is added or removed from the available resources or where some parameters of the resources are changed. The ANDSF may inform the terminals about the changed data without waiting for requests from the terminals.

FIG. 2C illustrates a simplified example of a user terminal of an embodiment.

The apparatus of the example includes a communication control circuitry 230 configured to control at least part of the operation of the user terminal.

The apparatus may comprise a memory 232 for storing data. Furthermore the memory may store software executable by the control circuitry 230. The memory may be integrated in the control circuitry. The software may comprise a computer program comprising program code means adapted to perform any of steps described above and below in relation to a user terminal 122.

The apparatus comprises a transceiver 234 operationally connected to the controller 230. The transceiver 234 is configured to set up and maintain a wireless connection to a communication system via an eNodeB on a given carrier or via another communication node. The transceiver 234 is operationally connected to an antenna arrangement 236. The antenna arrangement may comprise a set of antennas. The number of antennas may be one to four, for example. The number of antennas is not limited to any particular number.

The apparatus may comprise more than one transceiver. For example, the apparatus may comprise a WLAN, WIMAX or a satellite transceiver al operationally connected to the controller and an antenna arrangement.

The apparatus 110 may further comprise a universal subscriber identity module (USIM) 240 on a removable USIM card, for example. The SIM stores the service-subscriber key, such as an International Mobile Subscriber Identity (IMSI) which is used to identify a subscriber on communication networks.

The apparatus 110 may further comprise user interface 238. The user interface may comprise a speaker, a keyboard, a display, a microphone and a camera, for example.

The memory 232 may be configured to store communication related data. The communication system may be configured to send the user terminal information related to the communication parameters of the system. For example, when a USIM card is inserted into the terminal and the terminal is powered up for the first time, the system may be configured to send the terminal messages comprising information how to connect to short message center of the system and the Access Network Discovery and Selection Function server ANDSF 122 of the system. The information may comprise the IP address of the ANDSF, for example. The information may be stored to the memory 232. Thus the terminal is able to connect to the ANDSF of the system on the basis of the information at any time.

In an embodiment, the ANDSF of the system may be contacted using any access technology supported by the user terminal. The communication may be performed using IP regardless of the access method. This provides the user terminals of the communication system an efficient approach to obtain the necessary information of e.g. the available frequency bands, RATs, services, network policies. The user terminal may easily obtain CPC by contacting the ANDSF.

In an embodiment, the controller 230 of the user terminal may be configured to inform the ANDSF of the communication system the Cognitive Radio capabilities of the terminal. For example, information on the access technologies supported by the terminal may be send to the ANDSF. On the basis of the information the ANDSF may better tailor the CR information sent to the user terminal.

In an embodiment, the user terminal is configured to request the ANDSF for cognitive radio information. In an embodiment, the user terminal is configured to receive from the ANDSF cognitive radio parameters automatically whenever the parameters have changed.

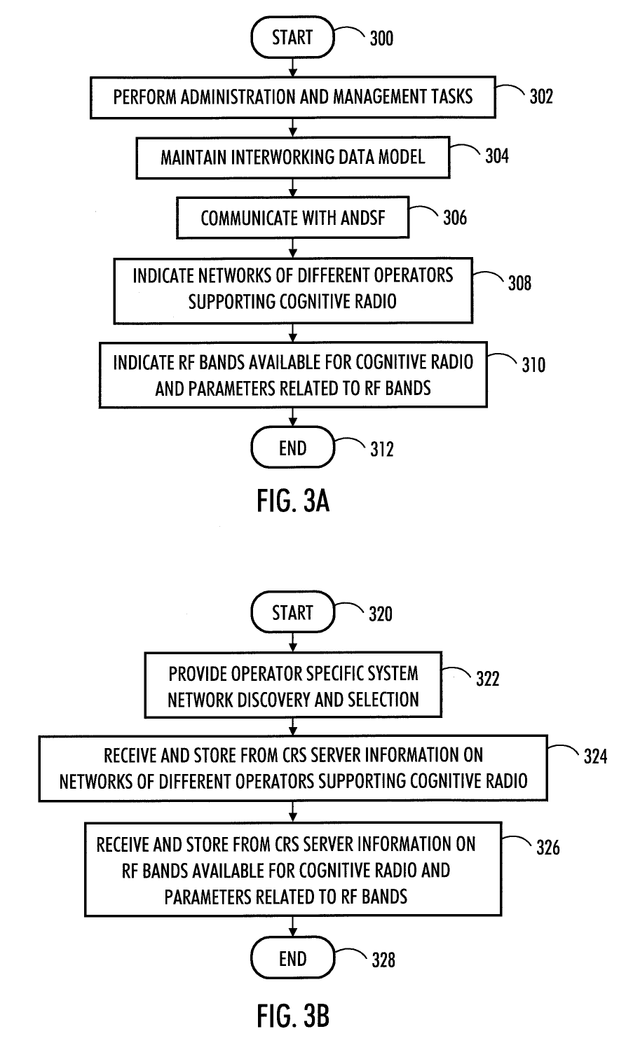

The embodiments are not restricted to the network given above as an example, but a person skilled in the art may apply the solution to other communication networks provided with the necessary properties. For example, the connections between different network elements may be realized with Internet Protocol (IP) connections. FIGS. 3A and 3B are flowcharts illustrating examples of embodiments of the invention.

FIG. 3A illustrates example of the operation of a CRS server. The example starts at step 300.

In step 302, the server is configured to perform administration and management tasks of the operator specific communication system comprising one or more radio access technologies.

In step 304, an interworking data model comprising information on operator specific cognitive radio parameters and access policies related to networks of one or more operators is maintained at the server. The data model may be stored in the memory 202.

In step 306, the server is configured to communicate with a network element of the operator specific communication system configured to provide network discovery and selection with information elements.

In step 308, at least one element indicating networks of an operator or different operators supporting cognitive radio is communicated to ANDSF.

In step 310, at least one element indicating the radio frequency bands available for cognitive radio and parameters related to the frequency bands is communicated to ANDSF.

The process ends in step 312.

FIG. 3B illustrates example of the operation of ANDSF. The example starts at step 320.

In step 322, an operator specific communication system comprising one or more radio access technologies network discovery and selection is provided.

In step 324, the ANDSF is configured to receive and store from a network element configured to perform the administration and management tasks of the operator specific communication system information elements where at least one element indicates networks of an operator or different operators supporting cognitive radio.

In step 326, the ANDSF is configured to receive and store from a network element configured to perform the administration and management tasks of the operator specific communication system information elements where at least one element indicates the radio frequency bands available for cognitive radio and parameters related to the frequency bands.

The process ends in step 328.

The steps, messages and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, an electrical carrier signal, a telecommunications signal, and a software distribution package, for example. Depending on the processing power needed, the computer program may be executed in a single electronic digital computer or it may be distributed amongst a number of computers.

The apparatuses described above may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claims.

1. An apparatus, comprising:
at least one processor; and
at least one memory including computer program code, the at least one memory and the computer program code configured to, with the at least one processor, cause the apparatus at least to perform:
perform the administration and management tasks of the operator specific communication system comprising one or more radio access technologies, maintain an interworking data model comprising information on operator specific cognitive radio parameters and access policies related to networks of one or more operators and communicate with a network element of the operator specific communication system configured to provide network discovery and selection with information elements comprising
at least one element indicating networks of one operator or different operators supporting cognitive radio;
at least one element indicating the radio frequency bands available for cognitive radio and parameters related to the frequency bands.

2. The apparatus of claim 1, configured to communicate with the respective apparatuses of one or more communication systems of other operators with information elements comprising cognitive radio parameters and access policies related to networks of one or more operators.

3. The apparatus of claim 1, configured to communicate with a base station of the communication system with information elements comprising cognitive radio parameters and access policies related to networks of one operator or more than one operator.

4. An apparatus, comprising:
at least one processor; and
at least one memory including computer program code, the at least one memory and the computer program code configured to, with the at least one processor, cause the apparatus at least to perform:
provide an operator specific communication system
comprising one or more radio access technologies network discovery and selection, receive and store from a network element configured to perform the administration and management tasks of the operator specific communication system information elements comprising
at least one element indicating networks of one operator or different operators supporting cognitive radio;
at least one element indicating the radio frequency bands available for cognitive radio and parameters related to the frequency bands.

5. The apparatus of claim 4, wherein the apparatus is configured to send one or more user terminal of the system information regarding cognitive radio parameters related to networks of one or more operators.

6. The apparatus of claim 5, wherein the apparatus is configured to send parameters when requested by the user terminal.

7. The apparatus of claim 5, wherein the apparatus is configured to send the parameters automatically when the parameters have changed.

8. The apparatus of claim 4, wherein the apparatus is configured to communicate with the user terminals using Internet Protocol.

9. An arrangement, comprising:
a first server of an operator specific communication system configured to perform the administration and management tasks of the operator specific communication system comprising one or more radio access technologies, communicate with the respective server of one or more communication systems of another operators,
and a second server configured to
manage mobility policy of the operator specific
communication system, communicate with the user terminals of the system by transmitting information on inter-system radio access network selection and access, wherein the first and second server are configured each to maintain an interworking data model comprising information on operator specific cognitive radio parameters and access policies related to networks of one or more operators.

10. The arrangement of claim 9, wherein the first and second server are configured to maintain a data model comprising
information indicating the radio frequency bands are available for cognitive radio and the access type supported.

11. The arrangement of claim 9, wherein the first and the second server are configured to maintain a data model comprising information on the measurement parameters of frequency bands supporting cognitive radio.

12. A method, comprising:
performing the administration and management tasks of the operator specific communication system comprising one or more radio access technologies,
maintaining an interworking data model comprising
information on operator specific cognitive radio
parameters and access policies related to networks of one or more operators and communicating with a network element of the operator specific communication system configured to provide network discovery and selection with information elements comprising
at least one element indicating networks of one operator or different operators supporting cognitive radio;
at least one element indicating the radio frequency bands available for cognitive radio and parameters related to the frequency bands.

13. The method of claim 12, further comprising:
communicating with the respective apparatuses of one or more communication systems of other operators with information elements comprising cognitive radio parameters and access policies related to networks of one or more operators.

14. The method of claim 12, further comprising:
communicating with a base station of the communication system with information elements comprising cognitive radio parameters and access policies related to networks of one or more operators.

15. A method, comprising:
providing an operator specific communication system comprising one or more radio access technologies network discovery and selection,
receiving and storing from a network element configured to perform the administration and management tasks of the operator specific communication system information elements comprising
at least one element indicating networks of one operator or different operators supporting cognitive radio;
at least one element indicating the radio frequency bands available for cognitive radio and parameters related to the frequency bands.

16. The method of claim 15, further comprising: sending one or more user terminal of the system information regarding cognitive radio parameters related to networks of one or more operators.

17. The method of claim 16, further comprising: sending parameters when requested by the user terminal.

18. The method of claim 16, further comprising: sending the parameters automatically when the parameters have changed.

19. The method of claim 15, further comprising: communicating with the user terminals using Internet Protocol.

20. A computer program comprising program code means adapted to perform the steps of claim 12 when the program is run on a computer.
